(19) United States
(12) Patent Application Publication
(10) Pub. No.: US 2020/0397166 A1
(43) Pub. Date: Dec. 24, 2020

(54) TEXTURED LID FOR A DRINKING CONTAINER

(71) Applicant: TOMY International, Inc., Oak Brook, IL (US)

(72) Inventors: Joseph Palermo, Wrentham, MA (US); Ryan Michienzi, Cumberland, RI (US); Victoria Brown, North Providence, RI (US)

(21) Appl. No.: 16/444,886

(22) Filed: Jun. 18, 2019

(51) Int. Cl. A47G 19/22; B65D 47/12; B65D 43/02; B65D 53/02; B65D 25/28; A61J 9/00; B65D 47/40

(52) U.S. Cl. CPC A47G 19/2272; B65D 47/127; B65D 43/0231; B65D 47/40; B65D 25/2802; A61J 9/00; B65D 53/02

(57) ABSTRACT

A drinking container assembly can include a reservoir for storing a liquid, a substantially smooth textured drinking apparatus configured to channel the liquid, and a textured surface adjacent to the drinking apparatus.

### FIELD

The present disclosure relates generally to drinking containers, and more particularly, to spill-resistant drinking containers for children, such as those drinking containers commonly known as “sippy cups.”

### BACKGROUND

Drinking containers for infants and young children are generally provided with specially-designed collars or lids that prevent spills of liquid due to undeveloped motor skills of the infants and young children. Commonly, the specially-designed collar or lid includes a non-spill drinking spout extending from an upper surface of the collar or lid that releases liquid through the spout when an infant or young child places his or her mouth on the spout and applies a suction force to the spout. Such drinking containers are sometimes referred to as “sippy cups.”

Infants and young children often experience discomfort when growing or “cutting” new teeth (i.e. “teething”). Conventional sippy cups do not adequately alleviate teething discomfort. As such, there is an ongoing need for a sippy cup that can ease teething discomfort and pain.

### SUMMARY

Exemplary embodiments disclosed herein relate to a lid for a drinking container, such as a sippy cup, having a plurality of textures for teething relief.

According to a first embodiment, a drinking container assembly can include a reservoir for storing a liquid, a substantially smooth textured drinking apparatus configured to channel the liquid, and a textured surface adjacent to the drinking apparatus

According to one aspect, a lid member for a drinking container can include a first portion, a second portion, a third portion, a drinking mechanism associated with the first portion, a first teething texture disposed on the second portion, and a second teething texture disposed on the third portion. In some embodiments, the first teething texture can be texturally different from the second teething texture.

In another embodiment, a drinking container assembly can include a cup-shaped reservoir and a lid. According to an exemplary embodiment, the lid can include a first shoulder portion, a second shoulder portion, a center portion adjacent to the first shoulder portion and the second shoulder portion, a spout extending from the center portion, a first teething textured surface disposed on the first shoulder portion, and a second teething textured surface disposed on the second shoulder portion. In some embodiments, the first teething textured surface is texturally different from the second teething textured surface.

### BRIEF DESCRIPTION OF THE DRAWINGS

FIG. 1 is a front perspective view of a textured drinking container assembly, according to an exemplary embodiment.

FIG. 2 is a top plan view of the textured drinking container assembly of FIG. 1, according to an exemplary embodiment.

FIG. 3 is a front plan view of the textured drinking container assembly of FIG. 1, according to an exemplary embodiment.

FIG. 4 is a cross-section view of the textured drinking container assembly of FIG. 1, according to an exemplary embodiment.

FIG. 5 is a right side plan view of the textured drinking container assembly of FIG. 1, according to an exemplary embodiment.

FIG. 6 is a left side plan view of the textured drinking container assembly of FIG. 1, according to an exemplary embodiment.

FIG. 7 is an exploded view of the textured drinking container assembly of FIG. 1, according to an exemplary embodiment.

FIG. 8 is a front view of a handle ring for a textured drinking container assembly, according to an exemplary embodiment.

FIG. 9 is a right perspective view of the handle ring of FIG. 8, according to an exemplary embodiment.

FIG. 10 is a top plan view of the handle ring of FIG. 8, according to an exemplary embodiment.

FIG. 11 is an exploded view of an example embodiment of a textured drinking container assembly including the handle ring of FIG. 8, according to an exemplary embodiment.

FIG. 12 is a cross-section view illustrating a permanent connection between a lid member and a threaded collar, according to an exemplary embodiment.

### DETAILED DESCRIPTION

Exemplary embodiments described herein include a drinking container assembly (i.e. a sippy cup) having one or more textures disposed on a lid member of the drinking container assembly for teething relief. The one or more textures included on the lid member can include ridges, bumps, or any other type of texture that can soothe teething discomfort or pain. In some embodiments, the one or more textures can be disposed on the lid member adjacent to a drinking apparatus or mechanism (e.g. a spout, a nipple, a straw, an opening, or an activated seal) associated with the lid member. Furthermore, the one or more teething textures can be disposed over projections or flanges of the lid member, such as shoulders. Infants or young children can place their mouths on the sides of the lid member and rub their growing teeth and/or sensitive gums against the textures disposed on the lid member for teething relief.

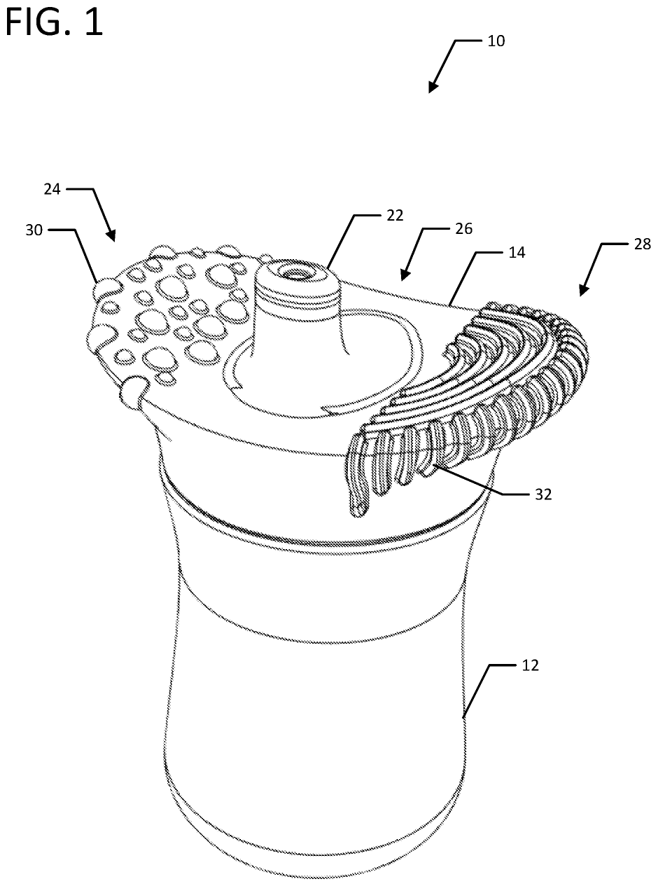

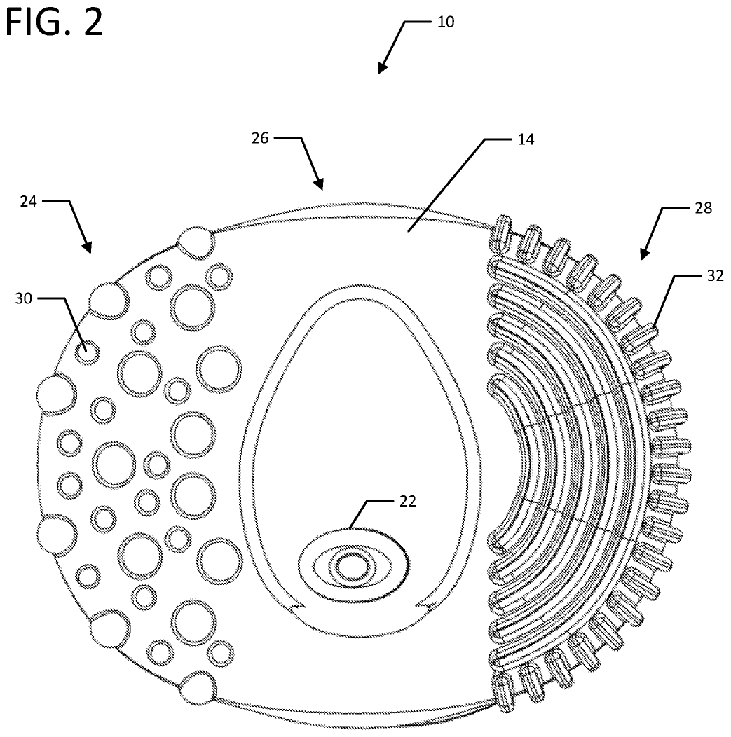

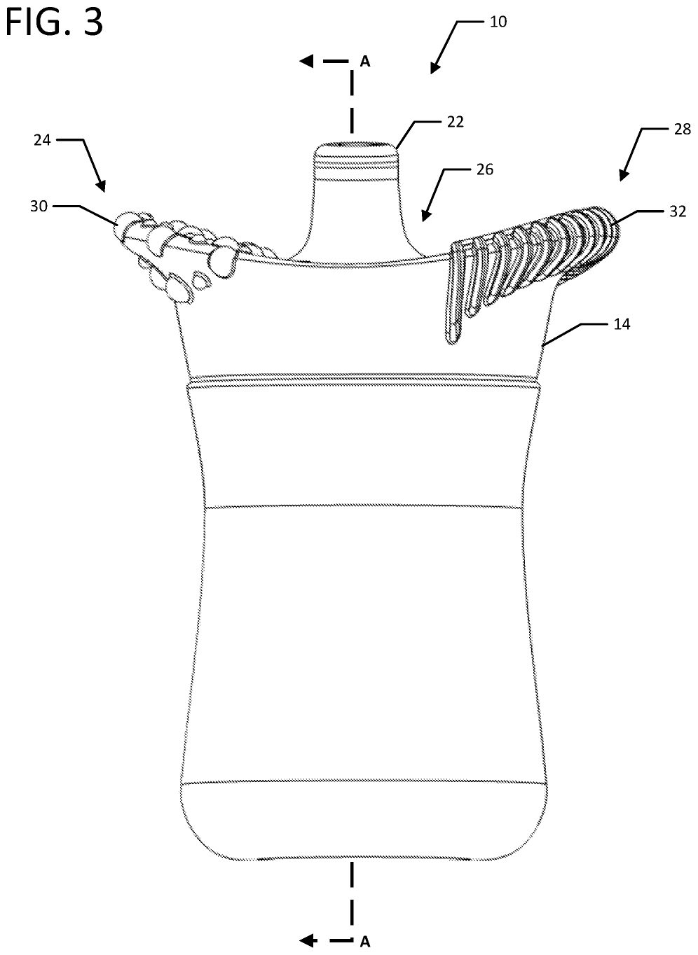

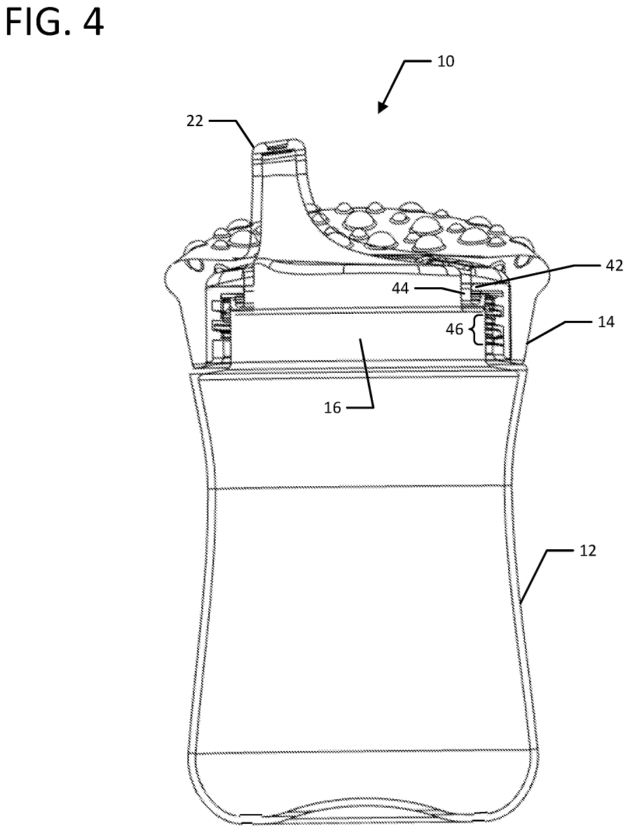

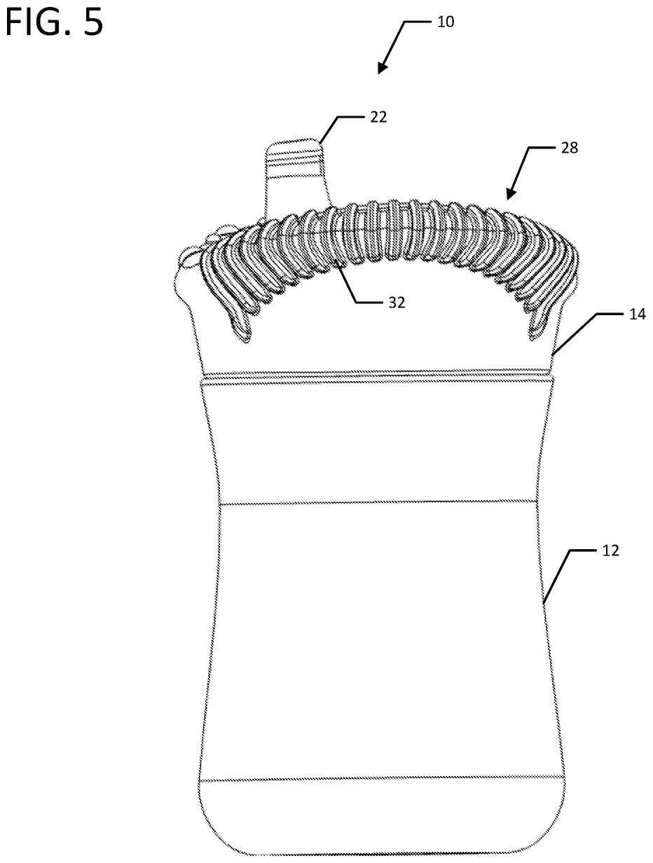

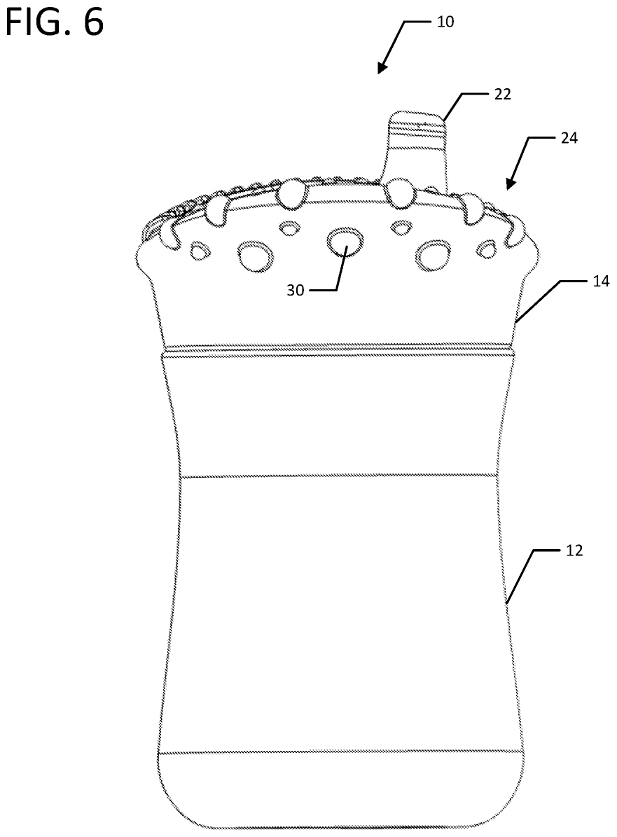

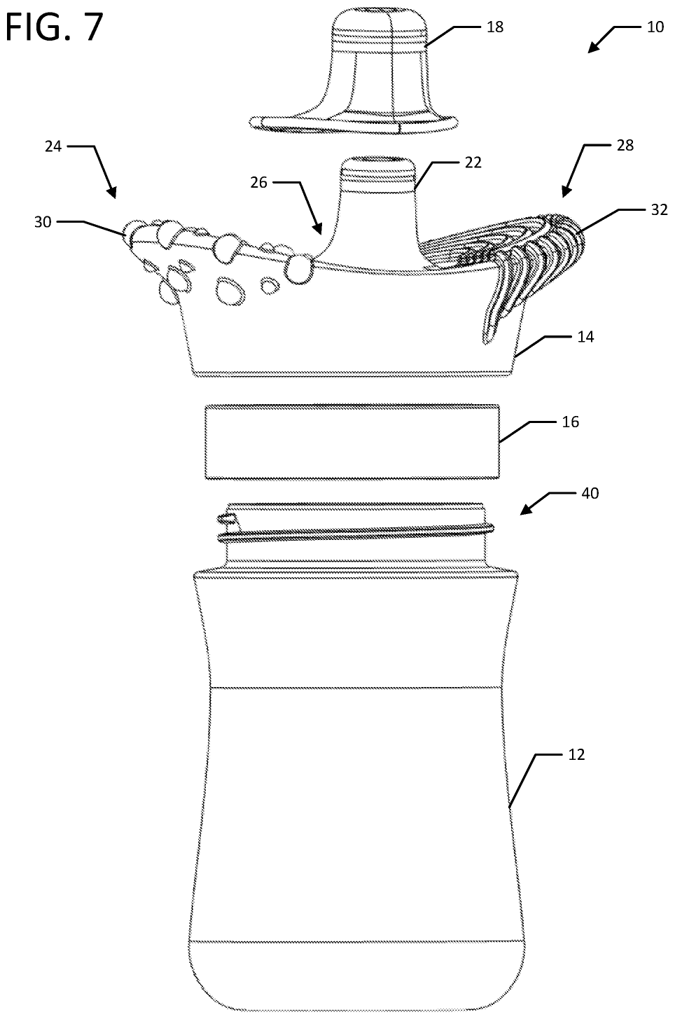

Referring generally to FIGS. 1-7, a drinking container assembly 10 can include a cup-shaped reservoir 12, a lid member 14, and a threaded collar 16. Optionally, the drinking container assembly 10 can include a spout cover 18 that can cover or protect a drinking spout 22 when not in use, when the drinking container assembly 10 includes a drinking spout 22. The lid member 14 can engage with the threaded collar 16 via a permanent or semi-permanent connection. For example, the threaded collar 14 can include a hook-shaped flange 42 that engages an extending lip 44 of the lid member 14 (see FIG. 4). Alternatively, the threaded collar 16 can engage with the lid member 14 via a friction fit. In yet another embodiment, the threaded collar 16 can engage with the lid member 14 via a permanent connection through over-molding of a silicone material comprising the lid member 14 (see FIG. 12). Furthermore, the threaded collar 16 can removably couple to the reservoir 12 via threading.

The cup-shaped reservoir 12 can be generally cylindrical in shape and sized to contain a liquid, such as water, milk, juice, or the like. For example, the reservoir 12 may be sized and shaped to hold approximately seven ounces of liquid in one embodiment or approximately nine ounces of liquid in another embodiment. In some embodiments, the reservoir 12 can comprise sidewalls formed of a polypropylene material. The reservoir 12 can include a threaded upper portion 40 that can engage corresponding threading 46 included as part of the threaded collar 16, thereby releasably coupling the reservoir 12 to the threaded collar 16.

The lid member 14 can be sized and shaped to cover a top opening of the reservoir 12 to prevent spills of the liquid from the reservoir 12. In some embodiments, the lid member 14 can comprise a silicone material. In some embodiments, the lid member 14 can prevent spilling when the extending lip 44 engages the hook-shaped flange 42 of the threaded collar 14. Although not shown, the drinking container assembly 10 can include a gasket or the like to provide additional protection against spills and leaks.

The lid member 14 can also include an air vent or the like to help regulate the flow of liquid while a user is drinking from the drinking container assembly 10. In an exemplary embodiment, the air vent can be disposed in a middle portion of the lid member 14.

The lid member 14 can include a first shoulder portion 24, a center portion 26, and a second shoulder portion 28. The spout 22 can extend from an upper surface of the center portion 26 of the lid member 14. While a spout 22 is shown in FIGS. 1-7, other drinking mechanisms or apparatuses can replace the spout 22, such as a nipple, straw, opening, or valve. The surfaces of the center portion 26 of the lid member 14 can be generally smooth and may omit any textures. In addition, the spout 22 can include an anti-spill valve arrangement that can be activated by a suction force applied by an infant or young child's mouth, as would be understood by one having ordinary skill in the art of sippy cups.

The lid member 14 can also include one or more texturally different textured surfaces 30, 32 for teething relief. In some embodiments, the first shoulder portion 24 of the lid member 14 can include a plurality of bumps 30 (or projections), and the second shoulder portion 28 of the lid member 14 can include a plurality of ridges 32. In some embodiments, the plurality of bumps 30 disposed on the first shoulder portion 24 of the lid member 14 can comprise bumps or projections of at least two sizes (e.g., small bumps and large bumps). Alternatively, in some embodiments, the plurality of bumps 30 may have more than two sizes. Furthermore, in some embodiments, the plurality of ridges 32 on the second shoulder portion 28 of the lid member 14 can comprise a plurality of concentric, semicircle-shaped ridges disposed on an upper portion (i.e. a top surface) of the second shoulder portion 28 and a plurality of parallel, vertical ridges on a side portion (i.e. a ridge or rim) of the second shoulder portion 28. According to an exemplary embodiment, the first and second textured surfaces 30, 32 can also comprise silicone, thereby making the textures soft. However, the textured surfaces 30, 32 can also comprise hard textures, such as those made from hard plastics (e.g. polypropylene).

As illustrated in FIG. 1, the first shoulder portion 24 and the second shoulder portion 28, on which the textured surfaces (e.g., the plurality of bumps 30 and the plurality of ridges 32, respectively) are formed, flare upwardly and/or outwardly from the center portion 26, which may enable the first shoulder portion 24 or the second shoulder portion 28 to extend slightly into a child's mouth and provide better teething relief, such as by reaching gums further within the child's mouth. The lid member 14 may be referred to as a sensory spout in some embodiments. While FIGS. 1-7 illustrate a lid member 14 having two different textured surfaces, the exemplary embodiments are not limited to a lid member 14 having two textured surfaces. In some embodiments, the lid member 14 includes only one type of textured surface (e.g. two pluralities of ridges or two pluralities of bumps). Furthermore, the lid member 14 may include more than two textured surfaces.

The threaded collar 16 can be sized and shaped to fit inside the lid member 14. In other words, a diameter of the threaded collar 16 can be slightly smaller than a diameter of the lid member 14. In an embodiment, the threaded collar 16 can have a substantially smooth outer surface for engaging with a substantially smooth inner surface of a lower portion of the lid member 14. For example, the threaded collar 16 can engage with the lid member 14 by a permanent or semi-permanent connection, such as co-molded, an adhesive, a friction fit, or the like. The threaded collar 16 can include a threaded inner surface 46 for releasably engaging with the threaded upper portion 40 of the reservoir 12. When the threaded collar 16 is engaged with the lid member 14, the threaded collar 16 enables the lid member 14 to removably engage with the reservoir 12 via threading. In some embodiments, the threaded collar 16 is molded of a polypropylene material. Optionally, the threaded collar 16 can include handles, as further described herein. In some embodiments, the threaded collar 16 can be omitted.

When present, the spout cover 18 can removably engage with the lid member 14 over the spout 22. The spout cover 18 can be sized and shaped to cover the spout 22. In some embodiments, the spout cover 18 can be molded of a polypropylene material. In some embodiments, the spout cover 18 can be omitted.

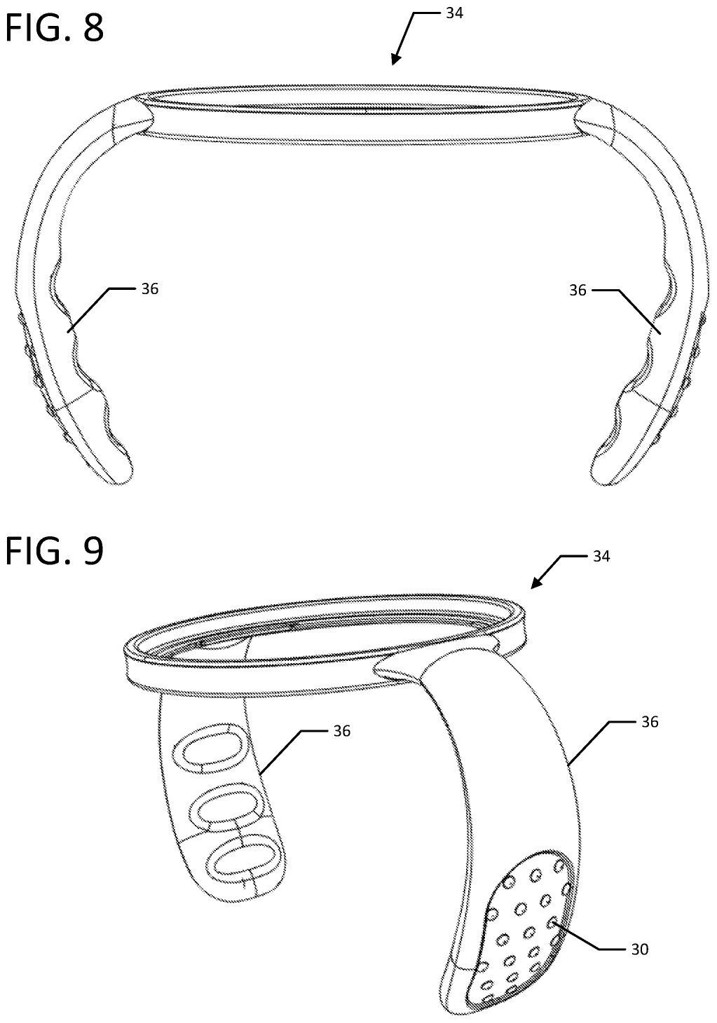

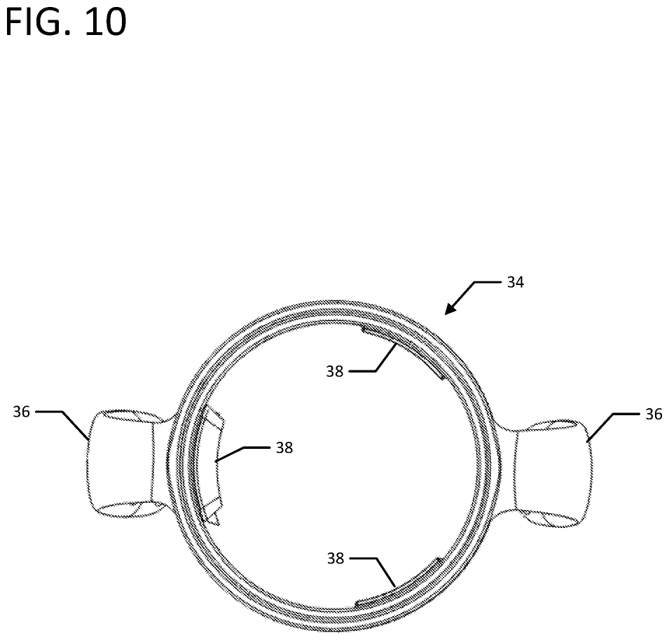

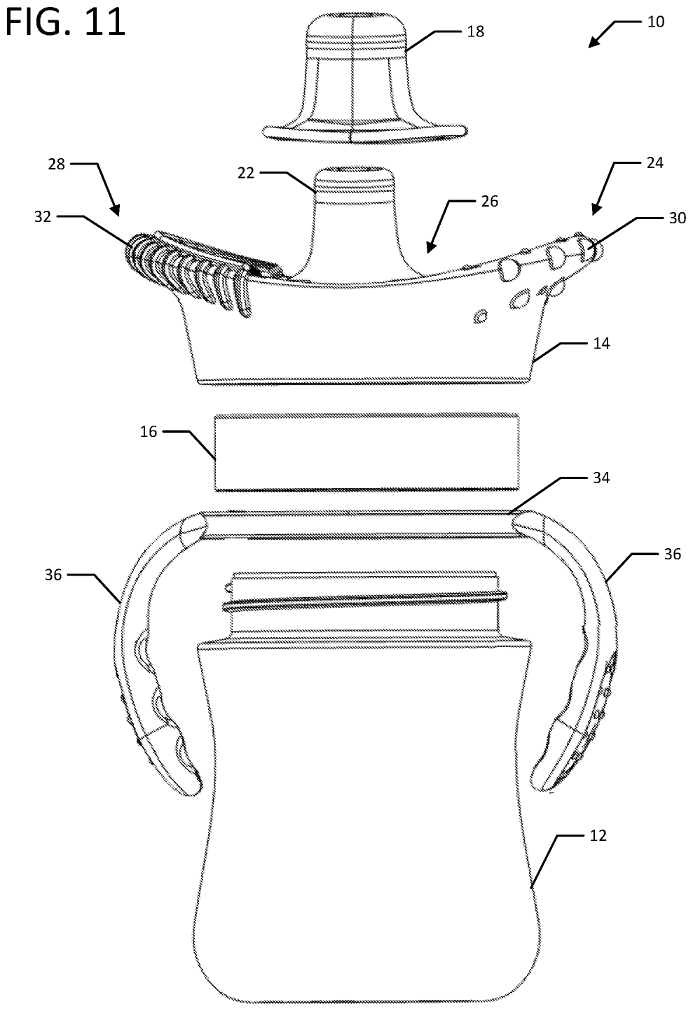

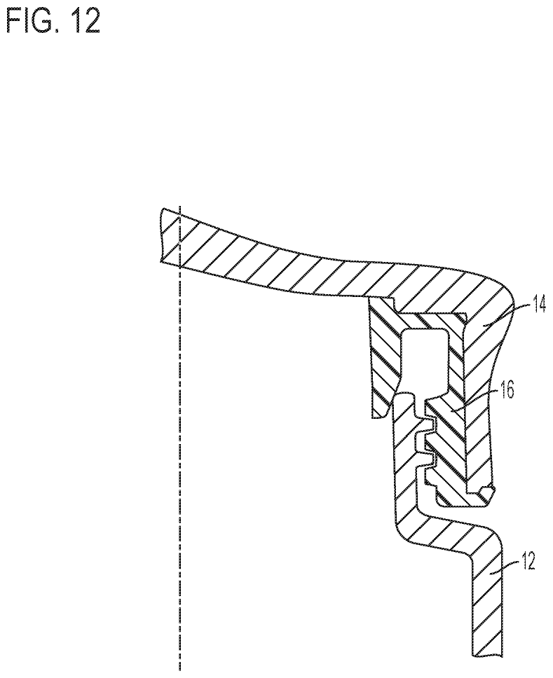

Referring generally to FIGS. 8-11, the drinking container assembly 10 may optionally include a handle ring 34 having handles 36 that can be used by an infant or young child to grab and hold the drinking container assembly 10. In some embodiments, the handles 36 can be semicircular, but the handles 36 are not limited to a semicircular shape. At least a portion of the surface of the handles 36 may include one or more textured surfaces for teething relief. For example, the handles 36 may include at least one of the same textured surfaces (e.g., bumps 30, ridges 32, etc.) as the lid member 14. In other embodiments, the handles 36 may include at least one textured surface that is different from the textured surfaces of the lid member 14. The handle ring 34 can include centering tabs 38 for centering the handle ring 34 on the reservoir 12. The handles 36 can enable a child to more easily grasp and drink from the drinking container assembly 10 because the child's hands can more easily fit around the handles 36, which have a smaller circumference than the reservoir 12.

While a sippy cup embodiment has been explicitly described and shown with reference to FIGS. 1-11, the exemplary embodiments are not limited to sippy cups. For example, the textured surfaces described herein can be disposed on open-top cups lacking a lid. In such an embodiment, one or more textured surfaces can be disposed on or around a rim of the cup. For example, the one or more textured surfaces can be disposed on both an external wall of the cup and an interior wall of the cup near the rim or lip of the cup. The open-top cup embodiment can also include flaring sides, such as flanges, that could extend into a user's mouth.

Additionally, the exemplary embodiments can apply to a spoutless sippy cup embodiment, such as The First Years® Simply Spoutless™ Cup, which prevents spills and allows an infant to sip from anywhere around a rim. In the spoutless sippy cup embodiment, one or more textured surfaces can be disposed on an external wall of a cup proximate to a seal of the spoutless sippy cup. Additionally, the seal itself can include a textured surface. According to an exemplary embodiment, the seal can include a first textured surface (e.g. projections), and the external wall of the cup or lid can include a second textured surface (e.g. ridges). Alternatively, the first textured surface can be disposed on both the seal and the external wall on a first side of the spoutless sippy cup, and the second textured surface can be disposed on both the seal and the external wall of a second side of the spoutless sippy cup.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.”

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A lid member for a drinking container comprising:
a first portion;
a second portion;
a third portion;
a drinking mechanism associated with the first portion;
a first teething texture disposed on the second portion; and
a second teething texture disposed on the third portion,
wherein the first teething texture is texturally different from the second teething texture.

2. The lid member of claim 1, wherein the first teething texture comprises a plurality of projections, and the second texture comprises a plurality of ridges.

3. The lid member of claim 2, wherein the plurality of projections includes projections having at least two different sizes.

4. The lid member of claim 2, wherein a first set of the plurality of ridges comprises one or more concentric, semicircle-shaped ridges on an upper portion of the third portion, and wherein a second set of the plurality of ridges comprises one or more vertical ridges on a side portion of the third portion.

5. The lid member of claim 1, wherein the first portion is substantially smooth.

6. The lid member of claim 1, wherein the second portion and the third portion each flare outwardly from the first portion.

7. The lid member of claim 1, wherein the second portion and the third portion extend upwardly from the first portion.

8. The lid member of claim 1, wherein the first portion, the second portion, and the third portion comprise a molded silicone material.

9. A drinking container assembly comprising:
a cup-shaped reservoir; and
a lid comprising:
a first shoulder portion;
a second shoulder portion;
a center portion adjacent to the first shoulder portion and the second shoulder portion;
a spout extending from the center portion;
a first teething textured surface disposed on the first shoulder portion; and
a second teething textured surface disposed on the second shoulder portion,
wherein the first teething textured surface is texturally different from the second teething textured surface.

10. The drinking container assembly of claim 9, further comprising a collar, wherein the lid engages the collar via a friction fit and is thereby removably engagable with the collar.

11. The drinking container assembly of claim 10, wherein the collar comprises first threading, wherein the cup-shaped reservoir comprises corresponding second threading, and wherein the first threading releasably engages with the second threading to couple the cup-shaped reservoir to the collar.

12. The drinking container assembly of claim 9, further comprising a handle ring having at least one handle extending therefrom.

13. The drinking container assembly of claim 12, wherein the first teething textured surface or the second teething textured surface is also disposed on the at least one handle.

14. The drinking container assembly of claim 12, wherein the at least one handle includes a third teething textured surface different from the first teething textured surface and the second teething textured surfaces.

15. The drinking container assembly of claim 9, wherein the first teething textured surface comprises a plurality of projections and the second teething textured surface comprises a plurality of ridges.

16. The drinking container assembly of claim 15, wherein the plurality of projections include projections having at least two different sizes.

17. The drinking container assembly of claim 15, wherein a first set of the plurality of ridges comprises one or more concentric, semicircle-shaped ridges on an upper portion of the second shoulder portion, and wherein a second set of the plurality of ridges comprises one or more vertical ridges on a side portion of the second shoulder portion.

18. The drinking container assembly of claim 9, wherein the center portion is substantially smooth.

19. The drinking container assembly of claim 9, wherein the first shoulder portion and the second shoulder portion each flare outwardly from the center portion.

20. A drinking container assembly comprising:
a reservoir for storing a liquid;
a substantially smooth textured drinking apparatus configured to channel the liquid; and
a textured surface adjacent to the drinking apparatus.

21. A lid member for a drinking container comprising:
a drinking mechanism configured to communicate liquid therethrough from the drinking container, wherein the drinking mechanism includes a substantially smooth drinking surface portion; and
a teething surface portion having disposed thereon a teething texture.
